(19) United States
(12) Patent Application Publication
(10) Pub. No.: US 2004/0153859 A1
(43) Pub. Date: Aug. 5, 2004

(54) Communication method for the realization of event channels in a time-driven communication system

(75) Inventor: Hermann Kopetz, Baden-Siegenfeld (AT)

Correspondence Address: Monte & McGraw, P.C., P.O. Box 650, 4092 Skippack Pike, Skippack, PA, 19474, US

(73) Assignee: FTS Computertechnik Ges.m.b.H., Baden-Siegenfeld (AT)

(21) Appl. No.: 10/660,817

(22) Filed: Sep. 11, 2003

(30) Foreign Application Priority Data
Mar. 19, 2001 (AT) A 429/2001
Mar. 19, 2002 (WO) PCT/AT02/00090

(51) Int. Cl. H04B 1/74

(52) U.S. Cl. 714/43

(57) ABSTRACT

The object of the present invention is to use a new communication method in a time-driven distributed real-time computer system to simplify the interface between the communication controller and a host computer in such a manner that the communication controller autonomously distinguishes between status data and event data and preprocesses the status data according to the status data semantics and the event data according to the event data semantics. Using this method, deterministic communication channels for the flexible transmission of event data can be constructed on a time-driven basic communication system. Different higher protocols, such as CAN or the OMG Internet Inter-ORB Protocol (IIOP), can then be implemented on these flexible event channels so that the known interfaces of these protocols can be made available to the host computer at the CNI (communication network interface). By pre-processing the information in the communication controller in a differentiated manner, composability during the transmission of event data can be attained, the operating system in the host computer can be simplified and the real-time performance of the host computer can be significantly improved. Furthermore, existing legacy software, such as for the CAN system, can be adopted without important changes.

### LITERATURE

Patents cited in [opposition]

U.S. patent:

U.S. Pat. No. 5,694,542 Dec. 2, 1997 Kopetz, H.

European Patent:

0658 257 Dec. 18, 1996 Kopetz, H. Kopetz, H. (1997). Real-Time Systems, Design Principles for Distributed Embedded Applications; ISBN: 0-7923-9894-7. Boston. Kluwer Academic publishers.

Maekawa, M. (1987) et. al., Operating Systems, ISBN 0-8053-7121-4, Menlo Park, Cal, Benjamin Cummings Publishing Company.

CAN (1990). Controller Area Network CAN, an In-Vehicle Serial Communication Protocol. SAE Handbook 1992, SAE Press. p. 20.341-20.355, Society of Automotive Engineers, Warrendale, Pa. USA. IOOP (1994). OMG's Internet Inter-ORB Protocol (IIOP), Object Management Group, Internet: www.omg.org, Boston, USA

### BACKGROUND OF THE PRESENT INVENTION

A distributed, fault-tolerant real-time computer system is made up of a number of computer nodes, each of which includes a host computer and a communication controller. The interface between host computer and communication controller is called a CNI (communication network interface). The communication controllers, together with their data links, form a real-time communication system through which status data and event data are exchanged.

As is explained in detail below, status data and event data have different semantics, which suggests a different processing in the communication system. This different processing in the communication system can be carried out either as a function of the application in the application software of the host computer, in the operating system of the host computer or it can be generically carried out in the communication controller (in the software or hardware). The present invention relates to an innovative method involving how such a processing of the status and event data can be generically carried out in the hardware/software of the communication controller. The transparent transmission of event data in a time-driven communication has the advantage that the precise interface definition in the time and value domain, and thus the composability of the architecture, are maintained. Further economic advantages are the reduction of the complexity of the operating system and of the extent to which the application software needs to be created time and again.

### ABSTRACT

The object of the present invention is to use a new communication method in a time-driven distributed real-time computer system to simplify the interface between the communication controller and a host computer in such a manner that the communication controller autonomously distinguishes between status data and event data and preprocesses the status data according to the status data semantics and the event data according to the event data semantics. Using this method, deterministic communication channels for the flexible transmission of event data can be constructed on a time-driven basic communication system. Different higher protocols, such as CAN or the OMG Internet Inter-ORB Protocol (IIOP), can then be implemented on these flexible event channels so that the known interfaces of these protocols can be made available to the host computer at the CNI (communication network interface). By pre-processing the information in the communication controller in a differentiated manner, composability during the transmission of event data can be attained, the operating system in the host computer can be simplified and the real-time performance of the host computer can be significantly improved. Furthermore, existing legacy software, such as for the CAN system, can be adopted without important changes.

### BRIEF DESCRIPTION OF THE DRAWINGS

The previously described objective and other new characteristics of the present invention are explained in the cited illustrations.

FIG. 1 shows the structure of a distributed real-time computer system.

FIG. 2 shows the structure of a computer node that is made up of a communication controller and a host computer.

FIG. 3 shows the structure of the CNI (communication network interface) interface between communication controller and host computer.

FIG. 4 shows a possible format of the messages that are exchanged between the computer nodes.

### DESCRIPTION OF AN EMBODIMENT

In the following section, a concrete embodiment of the new method is shown in the example of a distributed real-time system with four computer nodes that are connected via a real-time communication system. Status data and event data must generally be exchanged via such a real-time communication system.

Status data are data that provide information about the observed value of status variables. An observation of a status variable is an indivisible triple <Name of the status variable, Value of the status variable, Moment of the observation> as in described in detail in Kopetz 1997, p. 31. An example of a status element is the present position of a valve. The semantics of the status data suggest a new value of a status variable overwrites the existing old value and the value is not consumed as it is read, that is, the same value can be read multiple times. The possibility presents itself of configuring the interface between two subsystems that communicate via status data as a (dual-ported) memory interface. The transmitter must make sure that the currently valid value of a status variable is available in a data storage memory on the receiver side. A new status data value can overwrite the existing old value. The receiver, if it ever needs the value, can read out the current value from the local memory without consuming it via an information pull command.

Normally, status data are needed for periodic control processes. Therefore, they are periodically transmitted. We call the described kind of processing of status data status data semantics.

Event data are data that provide information about a change of status. An example of an event data element is the statement that the position of a valve has changed about 5 degrees. Such a change in status is characterized as an event. The event data provide information about the difference between the old status and the new status. Because the loss (or a duplication) of an event data element results in a loss of the status synchronization between transmitter and receiver, event data must be consumed by the receiver exactly once. Therefore, to save event data, a queue buffer, e.g., a ring buffer store, is suitable, whereby the transmitter is to be informed via an interrupt signal (information push) before the data memory becomes full and there exists the possibility of losing messages. Normally, event data are exchanged in real-time systems in the domain of the diagnosis and maintenance. We call the described type of processing of event data event data semantics.

Because any change of a status represents an event, there exists a close connection between status data and event data. It is possible on a high level of abstraction to depict the one transmission form and the other. However, in the specific application case there can be great differences in the efficiency of implementation between these two types of data transmission. If, for example, the status of an object changes only very seldom, then the periodic transmission of status data can lead to a high inefficiency of the data transmission. On the other hand, the periodic status data transmission offers a high degree of predictability and safety.

An important difference between status data transmission and event data transmission exists in the form of the interface, which is adapted to the semantics, between the communication controller and host computer of the receiver. With status data this interface can be designed as an information-pull interface. With an information-pull interface, the temporal control remains with the host computer, whose time behavior is not affected by the arrival of a new message. With event data, this interface is typically designed as an information-push interface. An information-push interface has the disadvantage that typically the time behavior of the host computer is affected by the arrival of a new message (interrupt processing), and as a result the composability of a system gets lost in the time domain. Because normally with an information-push interface, it is not known a priori when and how often the host computer is interrupted in order to process the event messages, the software in such a system cannot be encapsulated in terms of time in the host computer.

If a unified processing of status and event data is sought in a system, there is the following dilemma:

(i) The interface at the receiver is designed as an information-push interface. In this case, the composability gets lost.

(ii) The interface between communication controller and host computer is designed as an information-pull interface. In this case, event data can get lost.

In order to resolve this problem, a new method for the integration of status data transmission and event data transmission is proposed in the present invention. It is proposed that a communication channel having a ring buffer store be built a priori on a time-driven communication system, such as the TTP system, for the transmission of event data.

The invention is now explained with respect to the illustrations.

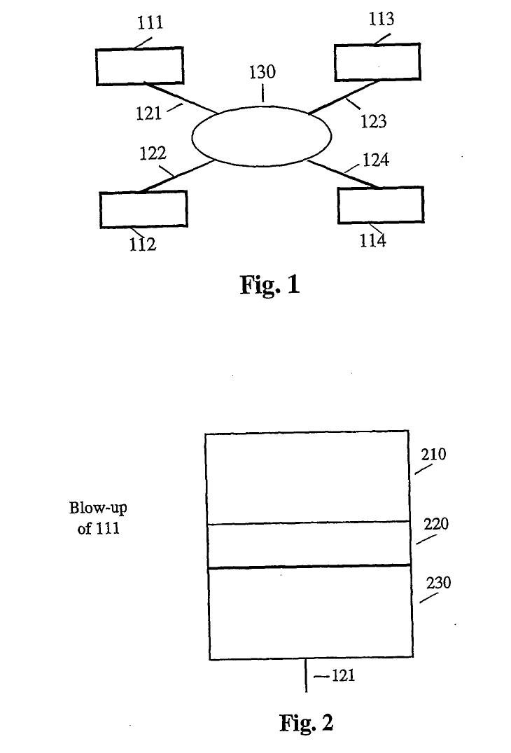

FIG. 1 shows a distributed computer system made up of four node computers 111, 112, 113, and 114, which are connected to each other via a communication system 130. This communication system can exchange messages, whereby the messages can contain either status data or event data (or both).

FIG. 2 shows the structure of a node computer 111 that is made up of two subsystems, communication controller 230 and host computer 210. Situated between these two subsystems is CNI (communication network interface) 220. This CNI is then manifested in various ways, depending on whether the messages contain status data or event data (or both types of data).

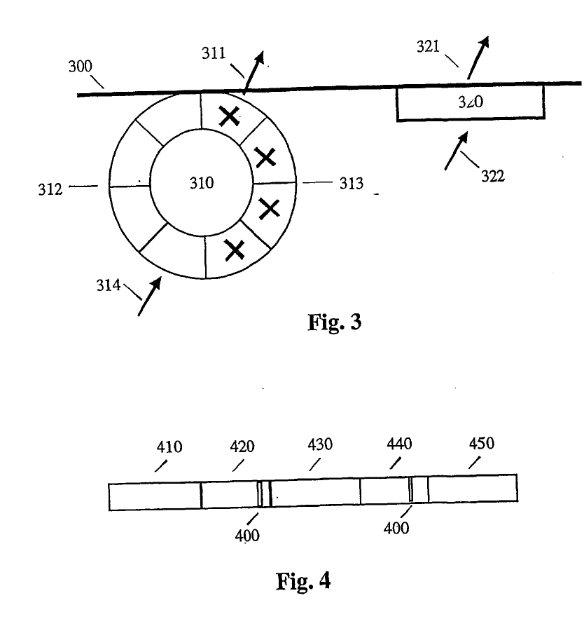

FIG. 3 shows the structure of CNI 220. Located at the border of communication controller 300 are two subsystems, subsystem 310 for processing event data and subsystem 320 for processing status data.

Subsystem 310 is made up of a ring buffer store, in the particular case with eight memory locations, the four memory locations 312 on the left being open in FIG. 3 and the four memory locations 313 on the right being assigned data elements. Connected to the ring buffer store are the two pointers 311 and 314. Pointer 311 points to the next data element to be consumed. After the consumption of a data element by the host computer, the pointer is changed so that it points toward the next data element to be consumed. Pointer 314 points to the next open memory location. After a new data element is saved by the communication system at the transmitter or receiver, pointer 314 is changed so that it points to the next open memory location. The detailed design of a ring buffer store is prior art and is described in detail in standard text books about operating systems, for example, Maekawa et. al., p. 21. The desired event semantics are implemented via the ring buffer store logic. In order to prevent a loss of data, the ring buffer store size must be matched to the processing frequency of the host computer in such a manner that an open place is always available for a newly arriving event message. If this is not the case, a fault situation is imminent (if the two pointers 311 and 314 run in conjunction) and is to be signaled to the host computer via an interrupt signal. In a correctly dimensioned system with an appropriate ring buffer store, even in a system that transmits event data to the host computer, there is no unplanned interruption. This is important, because any unplanned interruption violates the assumptions on which the WCET (worst case execution time analysis) of the host computer is based. The previously described method for the processing of event messages implements the required exactly-once semantics of the event data. In special cases, the ring buffer store can also have length 1.

Subsystem 320 is used for the storage of status data. It is made up of a dual-ported memory in which at the transmitter the host enters the last value of a status variable in the form update-in-place (overwriting), where the communication controller transmits the value of a status variable that is present at the time and where at the receiver the communication controller enters the arriving value in the form update-in-place (overwriting), which can be read once or multiple times in a non-consumptive manner by the host computer. Pointers 321 and 322 therefore always point toward the same memory location. The communication about status data that the semantics of the status data implement does not need such a complicated synchronization like the communication about event data.

FIG. 4 shows a possible format of a message. In the concrete example of FIG. 4, the message has five available fields. Located in first field 410, the header, is general information about the message, e.g., the type of message and who is sending the message. Field 420 contains indications about the data in ensuing field 430. In addition to general data, such as the name of the ensuing field, a special bit, discrimination bit 400, is located in this field and indicates whether the data in the ensuing field are status data or event data. Status data are to be provided according to the status data semantics (in subsystem 310), while event data must correspond to the event data semantics (subsystem 320). Ensuing field 430 then contains the data described in field 420. Finally, field 440 contains the indications about the data in field 450. In order to save transmission bandwidth, descriptive fields 420 and 440 can be partially or completely deposited in a memory of the receiving communication controller. For example, in a time-driven system, this information can be in a message descriptor list (MEDL), the connection between the data contents in fields 430 and 450 and locally stored descriptive fields 420 and 440 being produced during the time a message is arriving (see Kopetz 1997, p. 181, U.S. Pat. No. 5,694,542 and European Patent 0 658 257). The locally stored attributes can also be dynamically allocated to a message via the message names of an arriving message.

In order to be able to analyze a priori the time behavior of the host computer in real time, the maximum number of, and often also the moments of, the interruptions of the host computer that can occur in a time interval must be known. In a strictly event-driven system, such as the CAN network, the establishment of an upper box for the number of interruptions is difficult. By providing a ring buffer store in the CNI of the communication controller, the interface for transmission of event data is converted from an information-push interface into an information-pull interface. The time behavior of systems that communicate via information-pull interfaces is substantially easier to analyze than the time behavior of systems with information-push interfaces.

In many cases the result of event data is determined by a higher protocol. In such a protocol a distinction must be made between protocol data and user data. In a time-driven system, it is possible to determine throughout the overall time which data are user data and which data are control data of the higher protocol. This connection may also be produced via the current round position of a time-driven protocol. In order to achieve this, the communication controller can store, in addition to the data in the ring buffer store, also the moment of arrival of the message or the round position of the message at the receiver. The receiver, based on its a priori knowledge about the moments at which control data are sent out, can then interpret the data in the ring buffer store as control data.

The described method makes it possible to construct event data channels on a time-driven communication system such as the TTP system. Via the underlying deterministic time control, the data transmission is consistently regulated on these event channels on a system-wide basis. It would thus seem appropriate to implement known higher protocols, such as the CAN protocol or the OMG Internet Inter-ORB Protocol (IIOP) on these event channels. The data and control information can then be offered on CNI 220 according to the rules of this protocol. Thus, the existing software that was developed for this protocol can still be used on the host computer without substantial modifications.

In order to demonstrate the efficiency of this method, an example of implementing a CAN system on a TTP system is presented below.

Assumed that the TTP/C system is designed as follows:

Count number: 10

Speed: 10 Mbit/sec

Interframe gap: 10 μsec

Frame length: 400 bits, i.e. 50 Bytes (40 μsec)

TDMA round time 500 μsec

Event data 7 bytes, i.e. approximately 15% of the bandwidth of 50 bytes per frame

If one assumes the length of a CAN message with 14 bytes, then 1000 CAN messages per second can be transmitted in such a system with a guaranteed latency of 1 msec. Altogether, 10,000 CAN messages per second can thus be transmitted without affecting the remaining 85% of the bandwidth. The described method is also applicable to communication channels with very high bandwidths in the gigabit range. A further significant advantage of this method consists in the fact that the composability and the determinism of the architecture that is necessary for a transparent implementation of error tolerance is kept the same. In an implementation, set up on TTP platform, of the CAN protocol in the TTP communication controller, the priority logic of CAN can be implemented on the transmitter side and the known message filtering method of the CAN protocol can be implemented on the receiver side.

The described method can be implemented in software as well as in a micro-program of the communication controller. Technically, this method can also be realized by the implementation of a state machine directly in the hardware of the communication controller.

To summarize, the following economic advantages emerge from the new communication method:

(i) On a time-driven real-time communication system, status data and event data can be transmitted in succession.

(ii) The bandwidth allocation between status data and event data can be established a priori.

(iii) All interfaces of the communication system are precisely specified in the time domain and in the value domain, whereupon the composability of the architecture is kept unchanged.

(iv) The transmission of the event data is deterministic, meaning that a necessary prerequisite exists for the implementation of active redundancy.

(v) The event data corresponding to the syntax and semantics of known widely distributed protocols are provided on the CNI, meaning that “legacy” software can continue to be used without a high transfer effort.

(vi) The described method is scalable on bandwidths in the gigabits/sec range, so that software that is constructed on the basis of existing protocols, such as CAN, which are limited in their speed by the arbitration procedure, can continue to be used even in time-driven systems with very high bandwidths.

1. A communication method for real-time applications in a distributed computer system, made up of a number of computer nodes 111, 112, 113 and 114, where each computer node is provided with a host computer 210 and a communication controller 230, where the communication network interface 220 is located between the communication controller 230 and the host computer 210, where the communication controllers 230 are connected via a communication system 130, and where each communication controller is provided with a local transmission memory and a local receiver memory for sending and receiving data, wherein the communication controller of a time-driven communication system decides on the basis of a discrimination bit whether a data element contains status data or event data and where the communication controller manages the status data in the form up-date-in-place by the host in the transmission memory, non-consuming reading by the communication controller out of the transmission memory, up-date-in-place by the communication controller in the reception memory and non-consuming reading by the host computer out of the reception memory and manages the event data in the form exact one-time storage of the host data in a ring buffer store of the transmission memory, consuming reading of the communication controller out of the ring buffer store of the transmission memory, exact on-time storage by the communication controller in a ring buffer store of the reception memory and consuming reading by the host computer out of the ring buffer store of the reception memory.

2. The communication method for real-time applications as described in claim 1, wherein the discrimination bits that distinguish between status data and event data are a part of the transmitted message.

3. The communication method for real-time applications as described in claim 1, wherein the discrimination bit that distinguishes between status data and event data is allocated a priori to the data name and can be derived from the data name.

4. The communication method for real-time applications as described in claim 1, wherein the discrimination bits that distinguish between status data and event data can be derived from the moment of arrival of a message.

5. The communication method for real-time applications as described in one or more of claims 1 to 4, wherein the communication controller at the receiver transmits an intercept signal to the host computer no later than immediately after the assignment of the last open element in the ring buffer store for event data in order to induce the host computer to consume the event data and provide memory space for the next event data elements.

6. The communication method for real-time applications as described in one or more of claims 1 to 5, wherein the communication controller at the receiver, based on the moment of arrival of a data element at the receiver, decides whether a data element contains user data or control data of a higher protocol.

7. The communication method for real-time applications as described in one or more of claims 1 to 6, wherein the communication controller at the receiver, based on the current round position of a time-driven protocol, decides whether a data element transmitted in this round contains user data or control data of a higher protocol.

8. The communication method for real-time applications as described in one or more of claims 1 to 7, wherein the communication controllers interpret the event data in the sense of an a priori known higher protocol and present them to the communication network interface 220 at the sender and at the receiver in the form as prescribed by this a priori known higher protocol.

9. The communication method for real-time applications as described in one or more of claims 1 to 8, wherein the communication controllers present the event data to the communication network interface 220 at the sender and at the receiver in the form as prescribed by the CAN protocol.

10. The communication method for real-time applications as described in one or more of claims 1 to 8, wherein the communication controllers present the event data to the communication network interface 220 at the sender and at the receiver in the form as prescribed by the OMG Internet Inter-ORB Protocol (IIOP).

11. A communication method for real-time applications as described in one or more of claims 1 to 8, wherein the communication controllers simultaneously simulate various higher protocols for the transmission of event data.

12. A communication controller for real-time applications, wherein the communication controller implements one or more of the procedural steps corresponding to claims 1 to 11 in the hardware by means of a state machine or in a micro-program.
